(19) United States
(12) Patent Application Publication
(10) Pub. No.: US 2025/0358773 A1
(43) Pub. Date: Nov. 20, 2025

(54) METHOD AND APPARATUS FOR POSITIONING IN WIRELESS COMMUNICATION SYSTEM

(71) Applicant: LG ELECTRONICS INC., Seoul (KR)

(72) Inventors: Seunggye HWANG, Seoul (KR); Hyunsoo KO, Seoul (KR); Jaenam SHIM, Seoul (KR); Andrey PUDEEV, Nizhny Novgorod (RU); Alexander SHIKOV, Nizhny Novgorod (RU); Ilya AVERIN, Nizhny Novgorod (RU); Alexander MALTSEV, Nizhny Novgorod (RU)

(73) Assignee: LG ELECTRONICS INC., Seoul (KR)

(21) Appl. No.: 18/867,652

(22) PCT Filed: Oct. 6, 2023
(86) PCT No.: PCT/KR2023/015376

§ 371 Date: Nov. 20, 2024

(30) Foreign Application Priority Data
Apr. 5, 2023 (RU) 2023108573

(51) Int. Cl. H04W 64/00; H04W 8/24

(52) U.S. Cl. CPC H04W 64/00; H04W 8/24

(57) ABSTRACT

Disclosure of this application is related to a method of performing measurement for positioning. The method may comprises performing a first type measurement for positioning including a carrier phase measurement (CPM); performing a second type measurement for positioning which is different from the first type measurement; and reporting both the first type measurement and the second type measurement, and wherein a number of time instances related to the second type measurement may be equal to or greater than that of the first type measurement.

### TECHNICAL FIELD

The present disclosure relates to a wireless communication system, particularly related to a method and an apparatus for a positioning procedure including measurement for positioning.

### BACKGROUND ART

Wireless access systems have been widely deployed to provide various types of communication services such as voice or data. In general, a wireless access system is a multiple access system that supports communication of multiple users by sharing available system resources (a bandwidth, transmission power, etc.) among them. For example, multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### DISCLOSURE

### Technical Problem

An object of the present disclosure is to provide a method of efficiently and accurately performing a positioning procedure and an apparatus therefor.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

In an aspect of the present disclosure, a method of performing measurement for positioning by a user equipment (UE) in a wireless communication system, may comprise performing a first type measurement for positioning including a carrier phase measurement (CPM); performing a second type measurement for positioning which is different from the first type measurement; and reporting both the first type measurement and the second type measurement, wherein a number of time instances related to the second type measurement may be equal to or greater than that of the first type measurement.

Preferably, the first type measurement may be performed based on a single time instance, and the second type measurement may be performed based on multiple time instances.

Preferably, a single result obtained from the second type measurement may be associated with a plurality of results obtained from the first type measurement.

Preferably, the plurality of results obtained from the first type measurement may have a plurality of time stamp values different from each other.

Preferably, the UE may transmit a UE capability report including at least one of first information regarding whether the UE supports the first type measurement, and second information related to a number of time instances supported by the UE for the second type measurement.

Preferably, the UE may receive third information regarding the number of time instances related to the second type measurement.

Preferably, the third information may include a minimum number of time instances related to the second type measurement.

Preferably, the UE may transmit a UE-preferred number of time instances related to the second type measurement.

Preferably, the first type measurement and the second type measurement may be reported through in a single measurement report.

Preferably, the single measurement report may include the number of time instances related to the second type measurement.

Preferably, the single measurement report may include time stamp information for the first type measurement.

Preferably, the time stamp information for the first type measurement may represent a time instance where the first type measurement is performed.

Preferably, the second type measurement may include at least one of a downlink-Reference Signal Time Difference (DL-RSTD) measurement, an uplink-relative time of arrival (UL-RTOA), or a reception-transmission time difference measurement.

A non-transitory medium storing instructions that cause a processor to perform the method may be provided according to other aspect of the present disclosure.

A device performing the method of performing measurement for positioning may be provided according to another aspect of the present disclosure.

### Advantageous Effects

According to the present disclosure, a positioning procedure may be efficiently and accurately performed in a wireless communication system.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### DESCRIPTION OF DRAWINGS

FIG. 1 illustrates physical channels and a general signal transmission method using the physical channels in a 3rd generation partnership project (3GPP) system as an exemplary wireless communication system;

FIG. 2 illustrates architecture of a 5G system applicable to positioning of a UE connected to an NG-RAN or an E-UTRAN;

FIG. 3 illustrates an observed time difference of arrival (OTDOA) positioning method;

FIG. 4 illustrates integer ambiguity resolution for ToA four different (right) sets of BSs;

FIG. 5 illustrates outliers discarding by minimization of the observations MSE;

FIG. 6 illustrates performance increase due to proper processing of the consequent series of PRS frames;

FIG. 7 illustrates messaging during CP positioning;

FIG. 8 illustrates UE positioning measurements in an embodiment of present disclosure;

FIG. 9 illustrates a method of performing measurement for positioning according to an embodiment of the present disclosure;

FIG. 10 illustrates an exemplary communication system applied to the present disclosure; and

FIG. 11 illustrates an exemplary wireless device applicable to the present disclosure.

### MODE FOR INVENTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3^{rd} generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

As more and more communication devices require larger communication capacities, the need for enhanced mobile broadband communication relative to the legacy radio access technologies (RATs) has emerged. Massive machine type communication (MTC) providing various services to inter-connected multiple devices and things at any time in any place is one of significant issues to be addressed for next-generation communication. A communication system design in which services sensitive to reliability and latency are considered is under discussion as well. As such, the introduction of the next-generation radio access technology (RAT) for enhanced mobile broadband communication (eMBB), massive MTC (mMTC), and ultra-reliable and low latency communication (URLLC) is being discussed. For convenience, this technology is called NR or New RAT in the present disclosure.

While the following description is given in the context of a 3GPP communication system (e.g., NR) for clarity, the technical spirit of the present disclosure is not limited to the 3GPP communication system. For the background art, terms, and abbreviations used in the present disclosure, refer to the technical specifications published before the present disclosure (e.g., 3GPP TS 38.211, 38.212, 38.213, 38.214, 38.300, 38.331, and so on).

In a wireless access system, a user equipment (UE) receives information from a base station (BS) on DL and transmits information to the BS on UL. The information transmitted and received between the UE and the BS includes general data and various types of control information. There are many physical channels according to the types/usages of information transmitted and received between the BS and the UE.

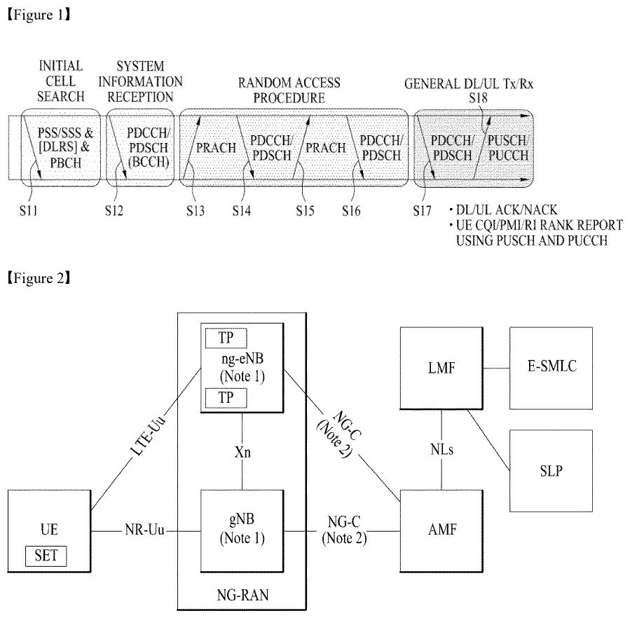

FIG. 1 illustrates physical channels and a general signal transmission method using the physical channels in a 3GPP system.

When a UE is powered on or enters a new cell, the UE performs initial cell search (S11). The initial cell search involves acquisition of synchronization to a BS. For this purpose, the UE receives a synchronization signal block (SSB) from the BS. The SSB includes a primary synchronization signal (PSS), a secondary synchronization signal (SSS), and a physical broadcast channel (PBCH). The UE synchronizes its timing to the BS and acquires information such as a cell identifier (ID) based on the PSS/SSS. Further, the UE may acquire information broadcast in the cell by receiving the PBCH from the BS. During the initial cell search, the UE may also monitor a DL channel state by receiving a downlink reference signal (DL RS).

After the initial cell search, the UE may acquire more detailed system information by receiving a physical downlink control channel (PDCCH) and a physical downlink shared channel (PDSCH) corresponding to the PDCCH (S12).

Subsequently, to complete connection to the BS, the UE may perform a random access procedure with the BS (S13 to S16). Specifically, the UE may transmit a preamble on a physical random access channel (PRACH) (S13) and may receive a PDCCH and a random access response (RAR) for the preamble on a PDSCH corresponding to the PDCCH (S14). The UE may then transmit a physical uplink shared channel (PUSCH) by using scheduling information in the RAR (S15), and perform a contention resolution procedure including reception of a PDCCH and a PDSCH signal corresponding to the PDCCH (S16).

When the random access procedure is performed in two steps, steps S13 and S15 may be performed as one step (in which Message A is transmitted by the UE), and steps S14 and S16 may be performed as one step (in which Message B is transmitted by the BS).

After the above procedure, the UE may receive a PDCCH and/or a PDSCH from the BS (S17) and transmit a physical uplink shared channel (PUSCH) and/or a physical uplink control channel (PUCCH) to the BS (S18), in a general UL/DL signal transmission procedure. Control information that the UE transmits to the BS is generically called uplink control information (UCI). The UCI includes a hybrid automatic repeat and request acknowledgement/negative acknowledgement (HARQ-ACK/NACK), a scheduling request (SR), channel state information (CSI), and so on. The CSI includes a channel quality indicator (CQI), a precoding matrix index (PMI), a rank indication (RI), and so on. In general, UCI is transmitted on a PUCCH. However, if control information and data should be transmitted simultaneously, the control information and the data may be transmitted on a PUSCH. In addition, the UE may transmit the UCI aperiodically on the PUSCH, upon receipt of a request/command from a network.

The UE may perform a network access procedure to perform the described/proposed procedures and/or methods. For example, the UE may receive and store system information and configuration information required to perform the above-described/proposed procedures and/or methods during network (e.g., BS) access. The configuration information required for the present disclosure may be received by higher-layer signaling (e.g., radio resource control (RRC) signaling, medium access control (MAC) signaling, or the like).

### Positioning

Positioning may refer to determining the geographical position and/or velocity of the UE based on measurement of radio signals. Location information may be requested by and reported to a client (e.g., an application) associated with to the UE. The location information may also be requested by a client within or connected to a core network. The location information may be reported in standard formats such as formats for cell-based or geographical coordinates, together with estimated errors of the position and velocity of the UE and/or a positioning method used for positioning.

FIG. 2 illustrates architecture of a 5G system applicable to positioning of a UE connected to an NG-RAN or an E-UTRAN.

Referring to FIG. 2, an AMF may receive a request for a location service associated with a particular target UE from another entity such as a gateway mobile location center (GMLC) or the AMF itself decides to initiate the location service on behalf of the particular target UE. Then, the AMF transmits a request for a location service to a location management function (LMF). Upon receiving the request for the location service, the LMF may process the request for the location service and then returns the processing result including the estimated position of the UE to the AMF. In the case of a location service requested by an entity such as the GMLC other than the AMF, the AMF may transmit the processing result received from the LMF to this entity.

A new generation evolved-NB (ng-eNB) and a gNB are network elements of the NG-RAN capable of providing a measurement result for positioning. The ng-eNB and the gNB may measure radio signals for a target UE and transmits a measurement result value to the LMF. The ng-eNB may control several TPs, such as remote radio heads, or PRS-only TPs for support of a PRS-based beacon system for E-UTRA.

The LMF is connected to an enhanced serving mobile location center (E-SMLC) which may enable the LMF to access the E-UTRAN. For example, the E-SMLC may enable the LMF to support OTDOA, which is one of positioning methods of the E-UTRAN, using DL measurement obtained by a target UE through signals transmitted by eNBs and/or PRS-only TPs in the E-UTRAN.

The LMF may be connected to an SUPL location platform (SLP). The LMF may support and manage different location services for target UEs. The LMF may interact with a serving ng-eNB or a serving gNB for a target UE in order to obtain position measurement for the UE. For positioning of the target UE, the LMF may determine positioning methods, based on a location service (LCS) client type, required quality of service (QOS), UE positioning capabilities, gNB positioning capabilities, and ng-eNB positioning capabilities, and then apply these positioning methods to the serving gNB and/or serving ng-eNB. The LMF may determine additional information such as accuracy of the location estimate and velocity of the target UE. The SLP is a secure user plane location (SUPL) entity responsible for positioning over a user plane.

The UE may measure the position thereof using DL RSs transmitted by the NG-RAN and the E-UTRAN. The DL RSs transmitted by the NG-RAN and the E-UTRAN to the UE may include a SS/PBCH block, a CSI-RS, and/or a PRS. Which DL RS is used to measure the position of the UE may conform to configuration of LMF/E-SMLC/ng-eNB/E-UTRAN etc. The position of the UE may be measured by an RAT-independent scheme using different global navigation satellite systems (GNSSs), terrestrial beacon systems (TBSs), WLAN access points, Bluetooth beacons, and sensors (e.g., barometric sensors) installed in the UE. The UE may also contain LCS applications or access an LCS application through communication with a network accessed thereby or through another application contained therein. The LCS application may include measurement and calculation functions needed to determine the position of the UE. For example, the UE may contain an independent positioning function such as a global positioning system (GPS) and report the position thereof, independent of NG-RAN transmission. Such independently obtained positioning information may be used as assistance information of positioning information obtained from the network.

Positioning methods supported in the NG-RAN may include a GNSS, an OTDOA, an E-CID, barometric sensor positioning, WLAN positioning, Bluetooth positioning, a TBS, uplink time difference of arrival (UTDOA) etc. Although any one of the positioning methods may be used for UE positioning, two or more positioning methods may be used for UE positioning.

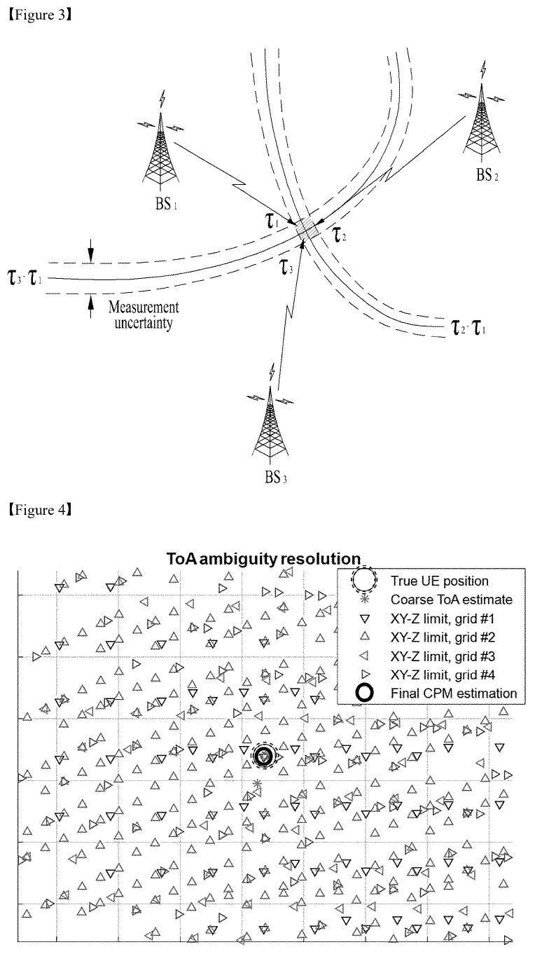

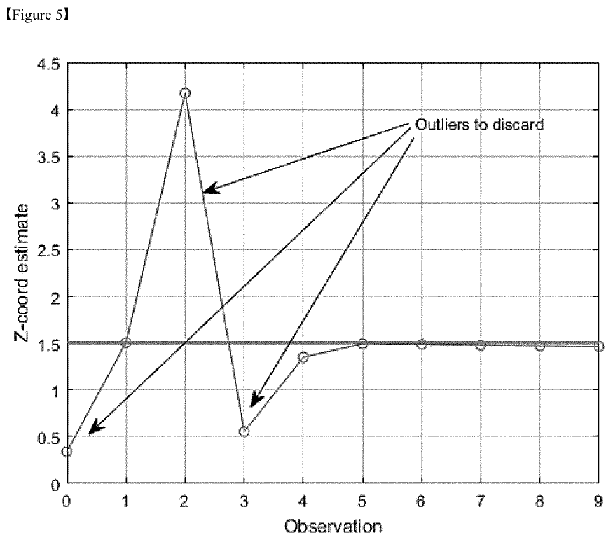

FIG. 3 is a diagram illustrating an observed time difference of arrival (OTDOA) positioning method;

The OTDOA positioning method uses time measured for DL signals received from multiple TPs including an eNB, an ng-eNB, and a PRS-only TP by the UE. The UE measures time of received DL signals using location assistance data received from a location server. The position of the UE may be determined based on such a measurement result and geographical coordinates of neighboring TPs.

The UE connected to the gNB may request measurement gaps to perform OTDOA measurement from a TP. If the UE is not aware of an SFN of at least one TP in OTDOA assistance data, the UE may use autonomous gaps to obtain an SFN of an OTDOA reference cell prior to requesting measurement gaps for performing reference signal time difference (RSTD) measurement.

Here, the RSTD may be defined as the smallest relative time difference between two subframe boundaries received from a reference cell and a measurement cell. That is, the RSTD may be calculated as the relative time difference between the start time of a subframe received from the measurement cell and the start time of a subframe from the reference cell that is closest to the subframe received from the measurement cell. The reference cell may be selected by the UE.

For accurate OTDOA measurement, it is necessary to measure time of arrival (ToA) of signals received from geographically distributed three or more TPs or BSs. For example, ToA for each of TP 1, TP 2, and TP 3 may be measured, and RSTD for TP 1 and TP 2, RSTD for TP 2 and TP 3, and RSTD for TP 3 and TP 1 are calculated based on three ToA values. A geometric hyperbola is determined based on the calculated RSTD values and a point at which curves of the hyperbola cross may be estimated as the position of the UE. In this case, accuracy and/or uncertainty for each ToA measurement may occur and the estimated position of the UE may be known as a specific range according to measurement uncertainty.

### Carrier Phase Positioning (CPP)

Following documents are incorporated by references:
[1] Intel, “Revised SID on Study on expanded and improved NR positioning” RP-213588, e-Meeting, Dec. 6-17, 2021
[2] RAN1 Chair's Notes, RAN1 #109-e, e-Meeting, May 9th-20th, 2022
[3] LGE, “Discussion on OFDM based carrier phase measurement in NR”, R1-2207710, Toulouse, France, Aug. 22-26, 2022
[4] Han Dun, Christian C. J. M. Tiberius, and Gerard J. M. Janssen, “Positioning in a multipath channel using OFDM signals with carrier phase tracking”, IEEE Access, vol. 8, pp. 13011-13028, January 2020

The 5G NR continues its expansion towards enriching its functionality to the new areas and use cases. Positioning, location management functionality is very useful side-feature of any communication system and its development continues within the specification. Staring from the simplest cell/sectors based location in the 2G/3G systems, the positioning accuracy significantly increased in the LTE releases. Scalable architecture of the 5G allow setting more challenging tasks for the positioning, and consider scenarios that may require millimeter accuracy. One of the examples of such scenario/usage model is the Indoor Factory, where 5G-NR based sensors may help to track containers and parts movements. Robotics and manufacturing applications require extremely precise positioning which cannot be achieved by conventional means.

Using conventional correlation-based positioning methods poses minimal requirements on the TX and RX radio frequency chains and transceivers synchronization/interoperation. For such approaches, accuracy strongly depends on the signal bandwidth, and thus limited by the available resources amount.

Sub-centimeter and millimeter positioning accuracy in this case can be reached only on the FR2 higher-frequencies, when more bandwidth can be allocated to the positioning purposes. Although, for FR1 frequencies below 6 GHz, total BW and thus positioning accuracy using baseband correlation and CIR estimation methods is limited.

One of the promising approaches to the high-precision positioning is the carrier phase positioning (CPP) based on the carrier phase measurements (CPM). For such approaches, accuracy depends mostly on the carrier phase frequency, which can be much larger than signal BW.

However, ability to estimate and track carrier phase of the signals imposes strict requirements on the generators stability and necessity to perform TX/RX chains calibration and synchronizations. Various differencing and double-differencing methods may be used to resolve the aforementioned difficulties.

Even in case of ideal phase sync of the TX and RX, there is a fundamental problem of phase periodicity-exact knowledge of the signal phase gives us only the fractional part of the wavelength distance measurements, while the integer part cannot be obtained through the phase measurements solely. This is a problem well-known as integer ambiguity resolution (IAR). Methods for integer ambiguity resolution successfully operate in the GPS systems and also considered for the CPM positioning in the OFDM systems [4]. Typical solutions that help to resolve the integer ambiguity in the modern positioning communication system are:
Using several (three or more) carriers
Using several reference points (satellites) for double differencing and TDoA positioning; and/op
Using constant signals that allows object tracking

For the carrier phase positioning system on the base of 5G NR framework, using several carriers for the sole purpose of the position is highly undesirable and thus, not considered. At the same time, packet-based network traffic with the multiple users transmitting the data as the main task with the positioning as secondary feature, the constant flow of specialized positioning signals is not possible. Regular distance estimate updates may not be available for the 5G NR system due to traffic prioritization and system load.

So, for the 5G NR CPP we have to propose the methodology that allows reliable IAR on the base of single carrier in the packet based mode, on the base of single- or multiple consequent observations (multiple samples/instances).

Consider the ToA geometry positioning as some function of the TRPs coordinates TRP xyz from subset of M base stations, and measured distances between the selected UE and m-th TRP.

$$= ToA ( , , .. ; {TRP}_{1}^{xyz} , {TRP}_{2}^{xyz} , ... {TRP}_{M}^{xyz} ) \qquad [ Equation 1 ]$$

The Equation 1 can be used to obtain coarse ToA position estimate, by employing the sub-optimal set of stations, as discussed in previous section.

With the carrier-phase distance measurements, there may be a high-accuracy estimate of the fractional wavelength part of the measured distance. The carrier phase estimation of the total distance will consist of the integer number N and the fractional part A as shown in Equation 2.

$${d}_{i}^{cpm} = {N}_{i} λ + {Δ}_{i} \qquad [ Equation 2 ]$$

With the baseline coarse distance measurements, an initial guess about the integer ambiguity, may be represented as Equation 3.

$${\overline{N}}_{ι} = ⌊ \frac{{\hat{d}}_{ι}}{λ} ⌋ , \qquad [ Equation 3 ]$$

However, this initial guess may differ from the real value N by the amount defined by underlying range measurements algorithm accuracy. For simplicity, consider 95-99% confidence interval of distance estimate d can be considered, which may be expressed in the wavelengths. For example, fog good 100 MHz estimates, the range value may be within three wavelengths from the initial coarse guess (N=3). Denoting this integer error value as K, the setting can be as follows:

$${N}_{i}^{k} ∈ {\overline{N}}_{ι} + k , k = - K .. K \qquad [ Equation 4 ]$$

With such preparations, the cloud of points in the 3D space may be obtained, corresponding to the solution of Equation 1 for all possible values of N:

$$= ToA ( {N}_{1}^{k 1} λ + {Δ}_{1} , {N}_{i}^{k 2} , .. {N}_{M}^{kM} ; {TRP}_{1}^{xyz} , {TRP}_{2}^{xyz} , ... {TRP}_{M}^{xyz} ) \qquad [ Equation 5 ]$$

Since, for every TRP and corresponding distance measurement d, the search should be performed independently, the total number of points in the cloud should be equal to the (2K+1) M.

Equation 5 provides the cloud of points, for each possible integer wavelength number per measured distance. True position is located among them, but single cloud is not enough for the ambiguity resolutions. Considering a single-packet measurement and there's no possibility to use different time observations, other sets of BSs may be employed for producing other clouds of points. Finding the point common to the all clouds can provide the solution of the integer ambiguity (see FIG. 4). Additionally, other limitations and cost-functions can be employed to select the true point among the clouds.

Simulations results showing that for the typical CPP test scenario, indoor factory (InF) with, single observation approach may give reliable IAR only for the relatively large signal BW (about 100 MHz). With such BW, initial coarse guess already pretty accurate, and IAR algorithms work fine.

However, for smaller signal BW, about 20-50 MHz, single measurement is not enough to reach target accuracy, and even reach 90% reliability of the IAR. Thus, multiple observation processing should be involved, and multiple consequent PRSs should be sent.

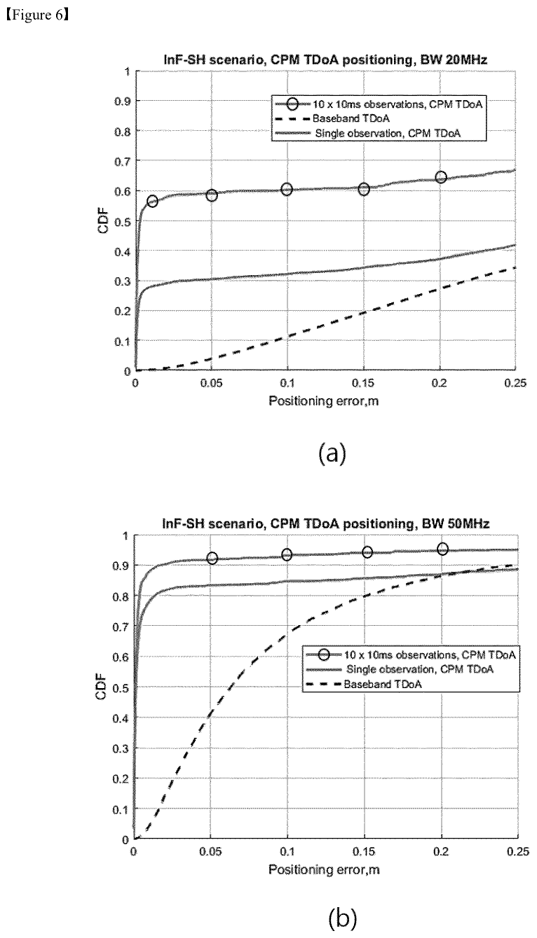

The processing of multiple observations may include the following steps:
Increasing the accuracy of the coarse baseband estimate (Equation 1)
Increasing the IAR resolution accuracy either by discarding the IAR outliers by using MSE minimization technique (see FIG. 5)

Application of the both techniques may significantly increase IAR reliability for the smaller BW signals.

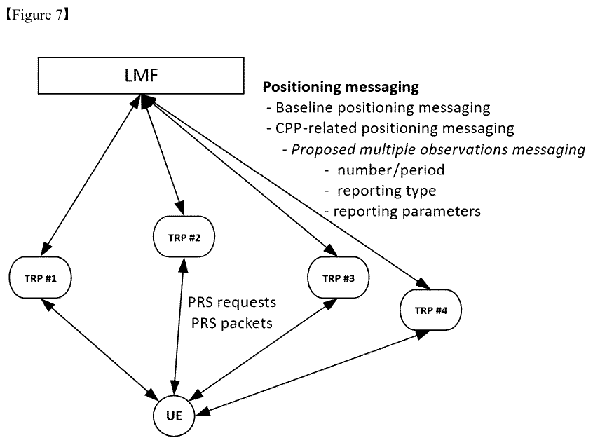

Simulation results in FIG. 6 shows the performance increase due to proper processing of the consequent series of PRS frames with the 10 ms period.

It can be seen that for (a) the 20 MHz correct IAR probability doubled, while for (b) the 50 MHz important 90% CDF level percentile can be reached with the proposed processing.

In accordance with an embodiment of the present disclosure, a method of combining the multiple observations may be provided for the carrier phase positioning in the 5G NR system.

Meanwhile, the existing 5G standard already has mechanisms for the consequent PRS transmission, with the given number of repetitions (dl-PRS-ResourceRepetitionFactor-r16) and duration between repetitions (dl-PRS-ResourceTimeGap-r16) informational elements. Here, the repetition mechanism included in the existing 5G standard is introduced to improve the SINR and accuracy in case of extremely bad channel conditions and long ranges. However, this repetition mechanism will not be triggered for typically good situations when CPP is possible.

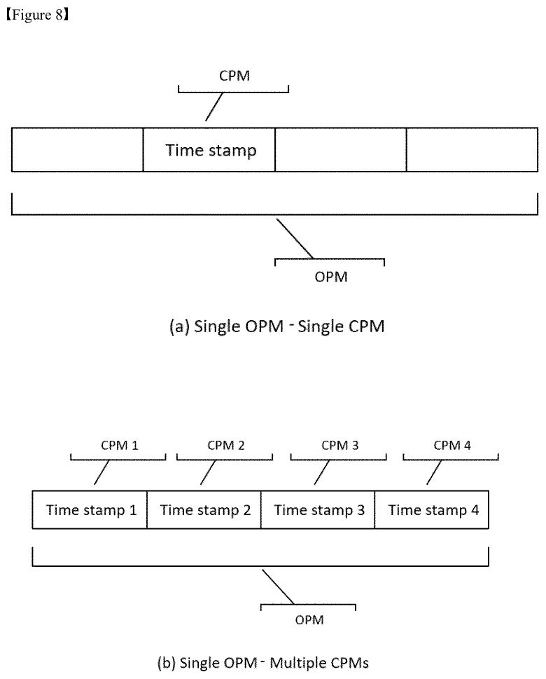

Thus, to ensure possibilities of PRS repetitions transmissions even in good SNR, TRP must know the CPP-related capabilities to the network (LMF, location management function). So, specific message, regarding the repetition series processing should be introduced within CPP-related messaging (see FIG. 7).

### (1) Remarks

As discussed above,
Using multiple observation can improve TDoA/ToA performance
Higher TDoA/ToA accuracy can be expected as more observations are used.
Improved TDoA/ToA accuracy can helps increasing integer value estimation
Consequently, CPP accuracy can be improved significantly, especially for the smaller BW size.
On the contrary, phase measurement accuracy hard to be improved with averaging multiple observations because of phase variation due to UE mobility
Hence, phase value shall be measured using single observation

### (2) Background

In the existing 5G standard:
Up to 4 observations can be used for a TDoA/ToA measurement
“Time stamp” can be reported together with positioning measurement (e.g. TDoA/ToA) to inform the LMF an information on timing that UE performs positioning measurements.
Time stamp is a frame/slot index where UE measure PRS. Single time stamp is reported even when multiple observations are used for measurement, and it is up to UE where to select
Assistance data can be used to aid LMF/gNB/UE for positioning related operations. For example, it can be used by LMF to recommend UE a suitable number of observations for a positioning measurement.
Capability signaling can be used to inform gNB/LMF the capability on a specific UE operation. Based on reported UE capability, LMF/gNB can determine what feature can be utilized by the UE and its associated limitation (e.g. Number of observation that UE can use for a measurement)

### (3) Proposals

Considering (1) Remarks and (2) Background (to enhance the existing 5G Std in view of (1))
When a UE reports CPM together with OPM (Other Positioning Measurements) (e.g. DL-RSTD, UL-RTOA, or UE/TRP Rx-Tx time difference), M≥1 samples (instances) can be used for OPM while N=1 sample (instance) is used for CPM.
The UE may report the UE capability for support of CPP to LMF/gNB and it expect N=1 is configured by default.
The UE may report the UE capability for support of measurements based on measuring M samples (or instances) of a DL-PRS resource set to LMF/gNB.
The LMF may indicate UE/gNB a minimum M value that is required for OPM measurement
The UE may provide the LMF with assistance data containing preferred M value
The LMF may provide the UE/gNB with assistance data containing M value recommendation
The UE/gNB may report actual M value, that is used for measuring OPM, together with positioning measurements in a positioning measurement report.
When the UE reports CPM together with OPM, time stamp can be reported in the same measurement report, wherein time stamp represents time instance where UE measure CPM.

In NR Rel-18 positioning, supporting UE to report CPM (Carrier Phase Measurement) together with OPM (Other Positioning Measurements; e.g. RSTD, RTOA, or Rx-Tx time difference) is considered for CPP (Carrier phase based positioning).

As discussed above, OPM can be used to resolve the integer ambiguity problem and, precise UE location can be estimated via CPM.

According to the evaluation results, it was observed that higher the OPM accuracy, the higher the CPP accuracy.

Also, higher OPM accuracy can be obtained as more samples are used for the measurement.

In NR positioning, M=4 samples are used to obtain an OPM as a baseline method.

Multiple samples usually guarantee high accuracy in the most of positioning measurements (e.g. time-domain based positioning method)

On the contrary, phase measurement accuracy hard to be improved with averaging multiple observations because of phase variation due to UE mobility.

Furthermore, to perform the double differencing technique which is useful to eliminate TX/RX initial phase error component, the location server may need to have exact knowledge about time instances where CPMs are performed.

Hence, CPM measurement with M=4 samples, e.g. averaging phase values estimated over 4 time instances, may not suitable in CPM report.

From these perspectives, positioning measurement reporting methods and its related procedures are proposed as follows:

When a Rx node reports CPM together with OPM (e.g. DL-RSTD, UL-RTOA, or UE/TRP Rx-Tx time difference), M≥1 samples (instances) are used for OPM while N=1 sample (instance) is used for CPM.
For example, UE may report DL-RSTD measurement obtained by averaging 4 samples with different time instances together with CPM obtained by 1 sample of an time instance.
For example, UE may report Rx-Tx time difference measurement obtained by averaging 4 samples with different time instances together with CPM obtained by 1 sample of an time instance.
For example, gNB may report UL-RTOA measurement obtained by averaging 4 samples with different time instances together with CPM obtained by 1 sample of an time instance.
For example, gNB may report Rx-Tx time difference measurement obtained by averaging 4 samples with different time instances together with CPM obtained by 1 sample of an time instance.

A Rx node may report multiple positioning measurement pairs in a positioning measurement reporting, and each positioning measurement pairs include a single OPM and a single associated CPM for a TRP (or RS resource)

A Rx node may report multiple positioning measurement pairs in a positioning measurement reporting, and each positioning measurement pairs include a single OPM and multiple associated CPMs for a TRP (or RS resource)
Each CPMs within a positioning measurement pair is measured at different time instance

When a Rx node reports CPM together with OPM, time stamp can be reported in each positioning measurement pairs, wherein time stamp represents time instance where Rx node measure CPM.
When positioning measurement pair contains single CPM, single time stamp for the CPM is reported
When positioning measurement pair contains multiple CPMs, time stamp corresponding to each CPM can be reported

To support the proposed methods, UE may report capability on CPP supports.

To support the proposed methods, UE may report capability on size(s) of M(s) supported, wherein M is a number of samples that could be supported for an OPM. To obtain higher accuracy than conventional methods, M>4 could be supported.

To support the proposed methods, the location server may configure M value to a Rx node. In this case, the Rx node measures an OPM using M sample observations while the Rx node measures a CPM using one sample observation.

To support the proposed methods, the location server may configure minimum M value that the Rx node shall consider as a minimum. In this case, the Rx node measures an OPM using M or more sample observations while the Rx node measures a CPM using one sample observation.

Beside the capability report, UE may request preferred M value to the location server via assistance data.

Beside the configuration, the location server may make recommendations of M value to gNB/UE via assistance data.

If M is determined by the Rx node, than the Rx node may be required to report M value that is used for the measurement in the report.

The proposed method can improve CPP accuracy performance.

The proposed method may beneficial when BW size for the positioning reference signal is restricted. For example, CPP accuracy of RedCap UE (i.e. max 20 MHz is allowed in FR1 range) can be improved when the proposed method is applied.

FIG. 8 shows an example of the proposed methods.

FIG. 8(a), shows an example when a positioning measurement pairs include a single OPM and a single associated CPM for a TRP (or RS resource). In this example, 4 time instances are used for measuring an OPM and one time instance is used for associated CPM. Also time stamp of the positioning measurement pair is determined by the time instance of the CPM.

FIG. 8(b), shows an example when a positioning measurement pairs include a single OPM and multiple associated CPMs for a TRP (or RS resource). In this example, 4 time instances are used for measuring an OPM and one time instnace is used for each associated CPM. Also, the time instances of each CPM are used to determine each time stamp.

FIG. 9 illustrates a method of performing measurement for positioning according to an embodiment of the present disclosure.

Referring to FIG. 9, the UE may perform different types of measurements for positioning (905). For example, the UE may perform a first type measurement for positioning including a carrier phase measurement (CPM) and a second type measurement for positioning which is different from the first type measurement. Preferably, a number of time instances related to the second type measurement may be equal to or greater than that of the first type measurement.

The UE may report the different types of measurements for positioning (910). For example, the UE may report both the first type measurement and the second type measurement.

Preferably, the first type measurement may be performed based on a single time instance, and the second type measurement may be performed based on multiple time instances.

Preferably, a single result obtained from the second type measurement may be associated with a plurality of results obtained from the first type measurement. Preferably, the plurality of results obtained from the first type measurement may have a plurality of time stamp values different from each other (e.g., FIG. 8(b)).

Preferably, the UE may transmit a UE capability report including at least one of first information regarding whether the UE supports the first type measurement, and second information related to a number of time instances supported by the UE for the second type measurement.

Preferably, the UE may receive third information regarding the number of time instances related to the second type measurement.

Preferably, the third information may include a minimum number of time instances related to the second type measurement.

Preferably, the UE may transmit a UE-preferred number of time instances related to the second type measurement.

Preferably, the first type measurement and the second type measurement may be included in a single measurement report.

Preferably, the single measurement report may include the number of time instances related to the second type measurement.

Preferably, the single measurement report may include time stamp information for the first type measurement.

Preferably, the time stamp information for the first type measurement may represent a time instance where the first type measurement is performed.

Preferably, the second type measurement may include at least one of a downlink-Reference Signal Time Difference (DL-RSTD) measurement, an uplink-relative time of arrival (UL-RTOA), or a reception-transmission time difference measurement.

A non-transitory medium storing instructions that cause a processor to perform the method may be provided according to other aspect of the present disclosure.

A device performing the method of performing measurement for positioning may be provided according to another aspect of the present disclosure.

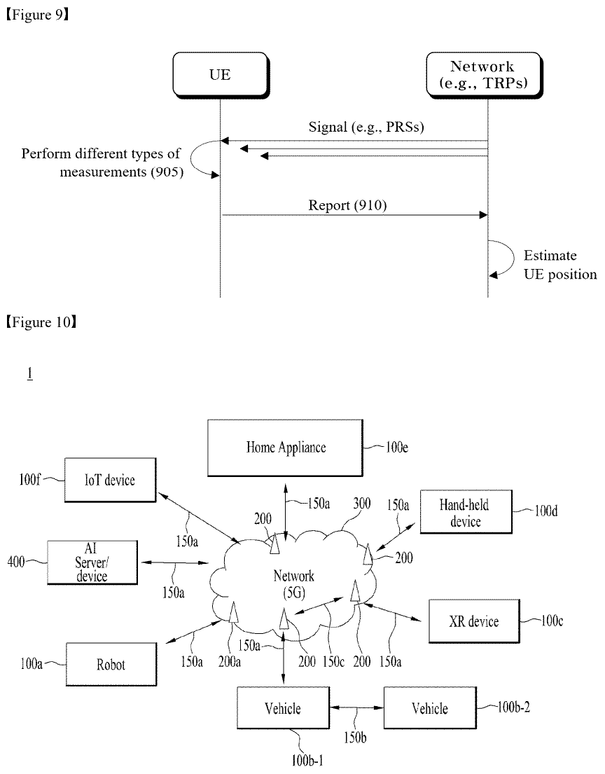

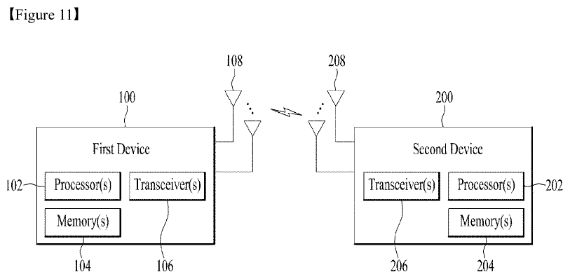

FIG. 10 illustrates a communication system 1 can be applied to the present disclosure.

Referring to FIG. 10, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smartglasses), and a computer (e.g., a laptop). The home appliance may include a TV, a refrigerator, a washing machine, and so on. The IoT device may include a sensor, a smartmeter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g. relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

FIG. 11 illustrates wireless devices applicable to the present disclosure.

Referring to FIG. 11, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 10.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by a subsequent amendment after the application is filed.

The embodiments of the present disclosure have been described above, focusing on the signal transmission and reception relationship between a UE and a BS. The signal transmission and reception relationship is extended to signal transmission and reception between a UE and a relay or between a BS and a relay in the same manner or a similar manner. A specific operation described as performed by a BS may be performed by an upper node of the BS. Namely, it is apparent that, in a network comprised of a plurality of network nodes including a BS, various operations performed for communication with a UE may be performed by the BS, or network nodes other than the BS. The term BS may be replaced with the term fixed station, Node B, enhanced Node B (eNode B or eNB), access point, and so on. Further, the term UE may be replaced with the term terminal, mobile station (MS), mobile subscriber station (MSS), and so on.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure may be used in a UE, a BS, or other devices in a mobile communication system.

1-15. (canceled)

16. A method performed by a user equipment (UE), the method comprising:
performing, based on N-sample, a first type measurement including a carrier phase measurement (CPM);
performing, based on M-sample, a reception-transmission time difference measurement; and
transmitting a measurement report including both the first type measurement related to the N-sample and the reception-transmission time difference measurement related to the M-sample,
wherein the number M related to the reception-transmission time difference measurement is equal to or greater than the number N related to the first type measurement.

17. The method of claim 16, wherein the first type measurement related to the N-sample incudes N CPM results for the N-sample.

18. The method of claim 17, wherein each CPM result is obtained for each sample.

19. The method of claim 16, further comprising:
transmitting a UE capability report including at least one of first information regarding whether the UE supports the first type measurement, and second information related to a number of samples supported by the UE for the reception-transmission time difference measurement.

20. The method of claim 16, further comprising:
receiving third information regarding the number N related to the reception-transmission time difference measurement.

21. The method of claim 20, wherein the third information includes a minimum number of samples related to the reception-transmission time difference measurement.

22. The method of claim 16, further comprising:
transmitting a UE-preferred number of samples related to the reception-transmission time difference measurement.

23. The method of claim 16, wherein the number N is 1 and the number Mis 4.

24. The method of claim 16, wherein the measurement report includes the number M related to the reception-transmission time difference measurement.

25. The method of claim 16, wherein the measurement report includes time stamp information for the first type measurement.

26. The method of claim 25, wherein the time stamp information for the first type measurement represents a time instance where the first type measurement is performed.

27. A non-transitory medium storing instructions, when executed by a processor of a user equipment (UE), that cause the UE to perform the method of claim 16.

28. A device comprising:
a memory configured to store instructions; and
a processor configured to perform operations by executing the instructions,
wherein the operations performed by the processor include:
performing, based on N-sample, a first type measurement including a carrier phase measurement (CPM);
performing, based on M-sample, a reception-transmission time difference measurement; and
transmitting a measurement report including both the first type measurement related to the N-sample and the reception-transmission time difference measurement related to the M-sample,
wherein the number M related to the reception-transmission time difference measurement is equal to or greater than the number N related to the first type measurement.

29. The device of claim 28, further comprising:
a transceiver,
wherein the device is a user equipment (UE) operating in a wireless communication system.

30. A method performed by at least one network node, the method comprising:
receiving, from a user equipment (UE), a measurement report for positioning,
obtaining, based on the measurement report, information regarding a first type measurement including a carrier phase measurement (CPM) and information regarding a reception-transmission time difference measurement,
wherein the first type measurement is related to N-sample,
wherein the reception-transmission time difference measurement is related to M-sample, and
wherein the number M related to the reception-transmission time difference measurement is equal to or greater than the number N related to the first type measurement.
